(19) United States
(12) Patent Application Publication
(10) Pub. No.: US 2009/0293016 A1
(43) Pub. Date: Nov. 26, 2009

(54) Adaptation of the presence status of instant messaging

(75) Inventors: Francois Potevin, Paris (FR); Michael Maillot, Issy Les Moulineaux (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/453,620

(22) Filed: May 15, 2009

(30) Foreign Application Priority Data
May 15, 2008 (FR) 0853139

(51) Int. Cl. G06F 15/16; G06F 3/048

(52) U.S. Cl. 715/810; 709/206

(57) ABSTRACT

A method of adapting an instant messaging status of a user of a terminal, comprising
receiving a message at the terminal by means of a wireless link,
determining on the basis of the received message a location cue for the terminal,
comparing the location cue for the terminal with at least one preregistered location cue, and
in the event of a positive comparison, the at least one prerecorded location cue being associated in memory with presence data predefined by the user, adapting the status of the user as a function of the presence data associated with the location of the terminal.

The invention pertains to the adaptation of the presence status of instant messaging.

Instant messaging services allow the real-time exchange of data, for example messages in text format or data files, between a user of a terminal, and one or more other persons, commonly called “contacts”, equipped with one or more other respective terminals.

The terminals may for example be computers, personal assistants of PDA type (“Personal Digital Assistant”), mobile telephones or the like.

In an instant messaging system, the user of a terminal is assigned a presence status, or instant messaging status, and has a list of contacts who are themselves assigned respective presence statuses.

The presence status of a user of an instant messaging service comprises a set of data, intended to be transmitted to the user's contacts, and the role of which is to provide these contacts with an indication as to the state of presence and of availability of the given user. The user's status is broadcast to the contacts of the list of contacts of this user. Vice versa, the user is informed of the statuses of the contacts of his list, these being displayed on his terminal.

The user's presence status may comprise a presence icon, having for example the form of a spot, selected from a set of icons corresponding respectively to various predefined statuses of the instant messaging, for example “online”, “busy”, “do not disturb”, “in a meeting”, etc. The user's presence status may also comprise a personal message, for example “at home”, “skiing until Sunday”, or “on leave until Monday”. This message is defined by the user himself and its object is to provide information that is complementary to the user's presence status and that generally relates to the user's situation (place where he is located, his circumstances, etc.).

On the basis of the user's status, a contact may decide to communicate with the user according to a synchronous or asynchronous mode, depending on whether the status indicates that the user is available or unavailable.

A user's status may be at least in part updated by the user. This updating being manual and on the initiative of the user, it is not systematic and depends greatly on the user's behaviour.

It may happen that the user forgets to modify his instant messaging status, thereby possibly causing his contacts to make an error. For example, when a user carries his terminal away with him from his place of work to his home, if the user does not update his status, the latter will indicate “on line available—in the office”. The user's contacts are led to believe that the user is at his place of work, and to refrain from initiating a conversation with the user, whereas the user is in fact at home.

There is therefore a requirement to make the updating of the instant messaging status of a user more systematic.

According to a first embodiment, the invention provides a method for adapting an instant messaging status of a user of a terminal, comprising

receiving a message at the terminal by means of a wireless link,
determining on the basis of the received message, a location cue for the terminal,
comparing the location cue for the terminal with at least one prerecorded location cue, and
in the event of a positive comparison, the at least one prerecorded location cue being associated in memory with presence data predefined by the user, adapting the status of the user as a function of the presence data associated with the location of the terminal.

Thus, the reception of a message from another device may bring about the modification of the instant messaging presence status.

The user of this terminal is exempted from performing this update manually.

Furthermore, there is no longer any risk of causing the contacts of the user to make an error on account of the user's forgetfulness, as in the prior art.

By improving the effectiveness of the presence function, this method makes it possible to optimize the use of instant messaging services.

For example, a user on returning home after a day at work, carries a terminal with him, for example a portable computer, and turns this portable computer back on. The portable computer detects a local WiFi network, receives the SSID (standing for “Service Set Identifier”) for this network, recognizes on the basis of the SSID received the network as being that of the user's home and modifies the presence status in such a way that the message “at home” is displayed on the screens of the terminals of the user's contacts.

The device transmitting the message to the terminal may for example comprise an access point of a wireless local area network, a base station of a cellular network, a geolocation satellite, or the like.

The wireless link may be a radio, Bluetooth, Infrared, HomeRF, WiFi, HiperLAN, GSM (standing for “Global System for Mobile communications”), GPRS (standing for “General Packet Radio Service”), UMTS (standing for “Universal Mobile Telecommunication System”), or other link.

The terminal may be connected to the instant messaging by the same access technology, or else by another access technology, for example Ethernet, GPS. This other access technology may be wired or wireless.

The location cue may be deduced from the message and from at least one other message received.

The location cue for the terminal may comprise an identifier of a wireless local area network, for example an SSID or a cell identifier. The network identified being local, the identifier provides a cue as to the location of the terminal.

The instant messaging presence state is thus coupled with an identifier of the wireless local area network detected by the terminal.

For example, one may associate a personalized presence message with each wireless network of a given type, for example WiFi, to which the terminal may be expected to connect.

The wireless local area network may be a network to which the terminal connects. Alternatively, the terminal may merely detect this network, access to this network being optionally prohibited to the terminal.

Alternatively, a plurality of messages are received from a plurality of respective devices separate from the terminal, for example satellites. Each of these messages may for example make it possible to estimate a distance between the corresponding satellite and the terminal. The location cue is determined on the basis of said plurality of messages, for example by triangulation. The geolocation cue may for example comprise spatial coordinates of the location of the terminal, or the like. The messages may be received by GPS (standing for “Global Positioning System”), or the like.

The invention is not limited by these examples of terminal location cues.

In the case where the location cue comprises an identifier of a wireless local area network, a step of detecting the local area network may be performed. This step may comprise the step of receiving the message, be performed prior to this receiving step, etc.

Further to the reception of the message, for a step of comparing the identifier of the local area network detected with at least one prerecorded identifier relating to at least one respective wireless local area network may be performed.

The local area network detected may for example be a Bluetooth, HomeRF, Infrared, WiFi, HiperLAN, or other network.

The identifiers relating to this at least one wireless local area network may be prerecorded in the terminal, or in any other device able to communicate with the terminal, such as for example a remote server. For example, a remote server may store a presence table which stores network identifiers, and for each network identifier stored, presence data corresponding to this network identifier. The presence data may correspond to messages of the type “at Mr and Mrs Martin's”, “In Deauville”, depending on the size of the corresponding network. The storing of this presence table in a remote server may enable a plurality of terminals to access one and the same table. This may be beneficial for example if the terminals of this plurality of terminals belong to the same person. Alternatively, the terminals of this plurality of terminals may belong to persons of one and the same company, or of one and the same service, and the network identifiers recorded in the presence table of the remote server may correspond to the locations at which these persons are liable to be found, for example at clients' homes. It would thus be possible for each person to know where his colleagues are by consulting the presence statuses of these colleagues.

Advantageously, there is provided a configuration step in the course of which at least one location cue, relating to a given location, is recorded in the terminal. For the given location, presence data are recorded in such a way as to be associated in memory with the corresponding location cue.

This configuration step may be performed just once, or a relatively restricted number of times, whereas the above steps of detection, comparison, etc. may be performed more frequently, for example on each relocation of the terminal.

The presence data may be input manually.

For example, the user lists in his terminal identifiers of the WiFi networks or the like to which the terminal is liable to connect regularly. For each identifier listed, a personalized presence message is input and recorded. The networks listed may be so-called “favourites”, and for each favourite network, a connection profile comprising an identifier of the network, for example an SSID, and if appropriate authentication data for the network, for example a WEP key (standing for “Wired Equivalent Privacy”), is recorded in the terminal.

When the terminal detects a local area network whose identifier does not agree with any of the possible identifiers already stored in the terminal, a message may be displayed so as to forewarn the user that a new local area network is detected, and suggest to him that he manually input presence data to be associated with this new network. If the user actually inputs presence data, corresponding for example to the message “In Crete until the 28^{th}”, these are stored, together with the identifier corresponding to the local area network detected.

The displaying of this message may be performed only when the terminal is in a certain operating mode. For example, display is performed only if a given mode bit has a predetermined value.

The invention is of course not limited by the presence of a mode bit conditioning the displaying of this message.

Alternatively, the presence data may be received from a device. For example, when a new local area network is detected, the terminal can dispatch a request message to a device, for example the device from which the message is received or a third party device. In response to this request, the presence data, corresponding for example to village name, are dispatched for storage.

The method according to an embodiment of the invention may be implemented only if a mode variable has a predetermined value. The user may thus configure his terminal for automatic or manual updating of the presence status.

The invention is of course not limited by the presence of this mode variable. The terminal may be programmed to operate solely with automated updating of the presence status.

According to another embodiment, the invention provides a terminal device equipped with an instant messaging service, and able to implement the method described herein above.

According to yet another embodiment, the invention provides a computer program intended to be stored in a memory of a terminal device equipped with instant messaging, and/or stored on a memory medium intended to cooperate with a reader of this device and/or downloaded via a telecommunication network. This program comprises instructions for implementing the method described herein above, when these instructions are executed by a processor of this terminal device.

Other features and advantages will become apparent from the detailed description hereinbelow, given with reference to the appended drawings in which:

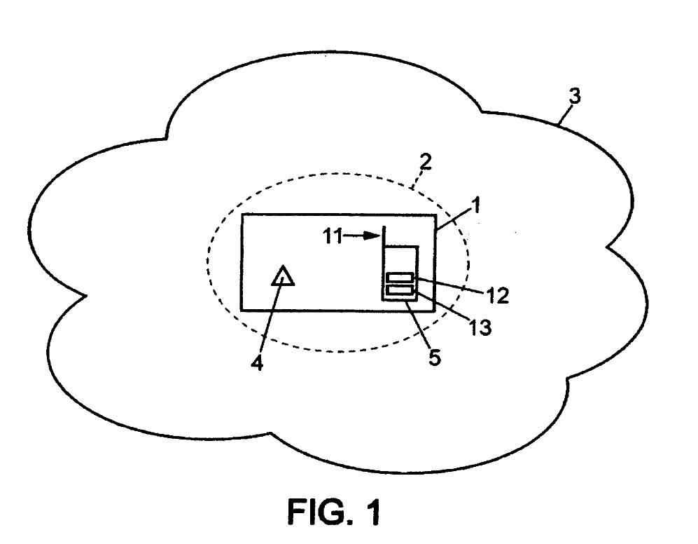

FIG. 1 shows a schematic view of an office building, of a zone of coverage of a wireless local area network, and of a zone of coverage of a wide area network.

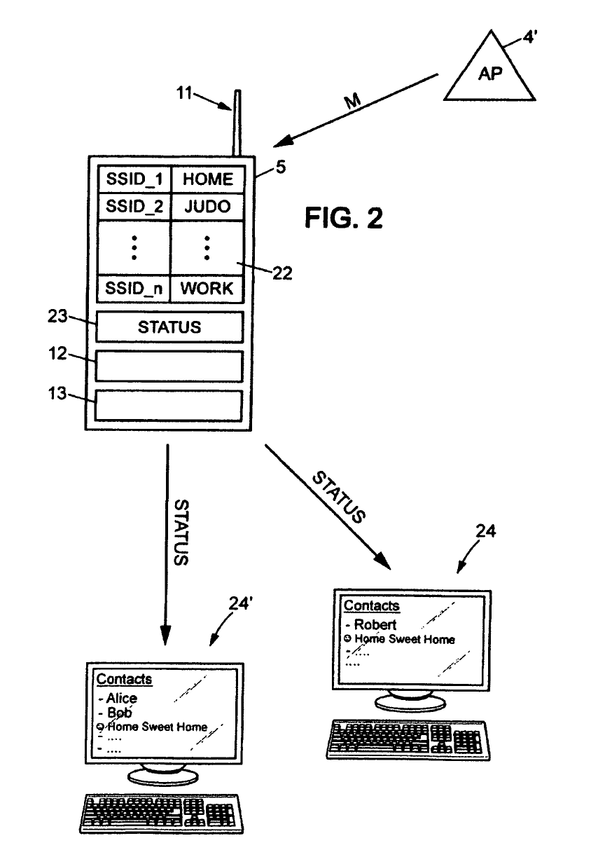

FIG. 2 shows an example of a terminal device according to an embodiment of the invention, a point of access to a wireless local area network, and terminals of contacts of the user of the terminal.

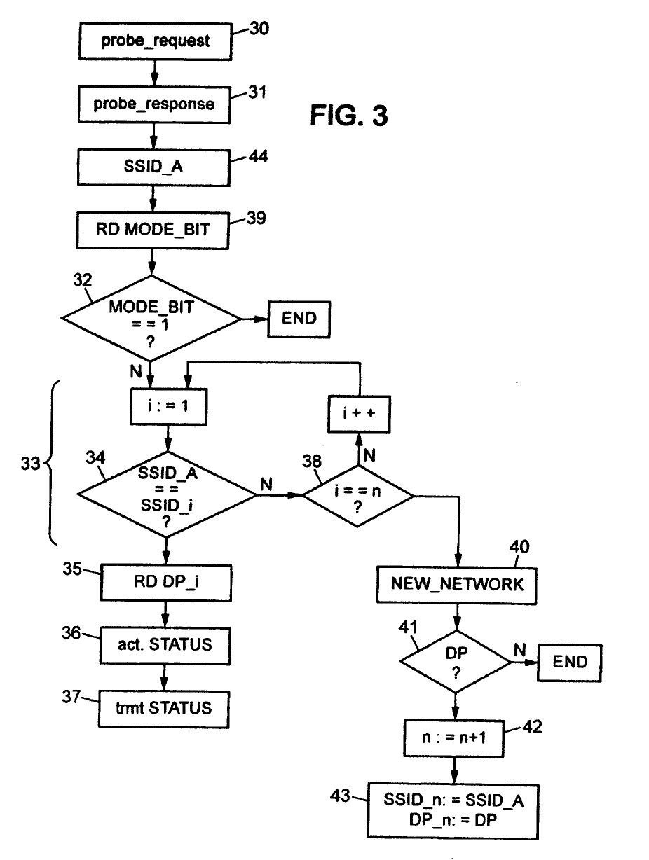

FIG. 3 is a flowchart of an exemplary method according to an embodiment of the invention.

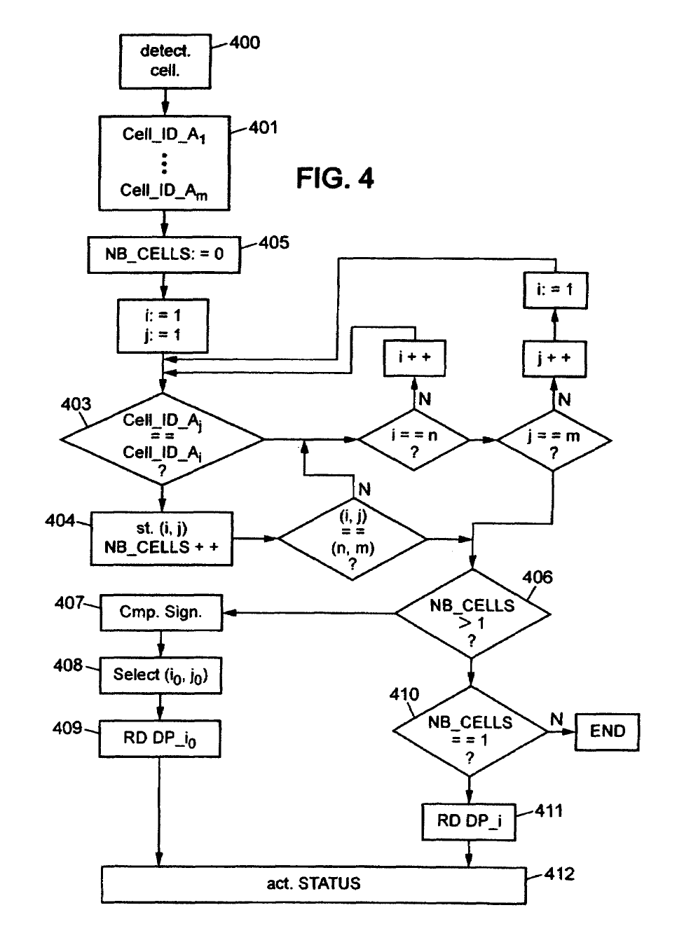

FIG. 4 is a flowchart of an exemplary method according to another embodiment of the invention.

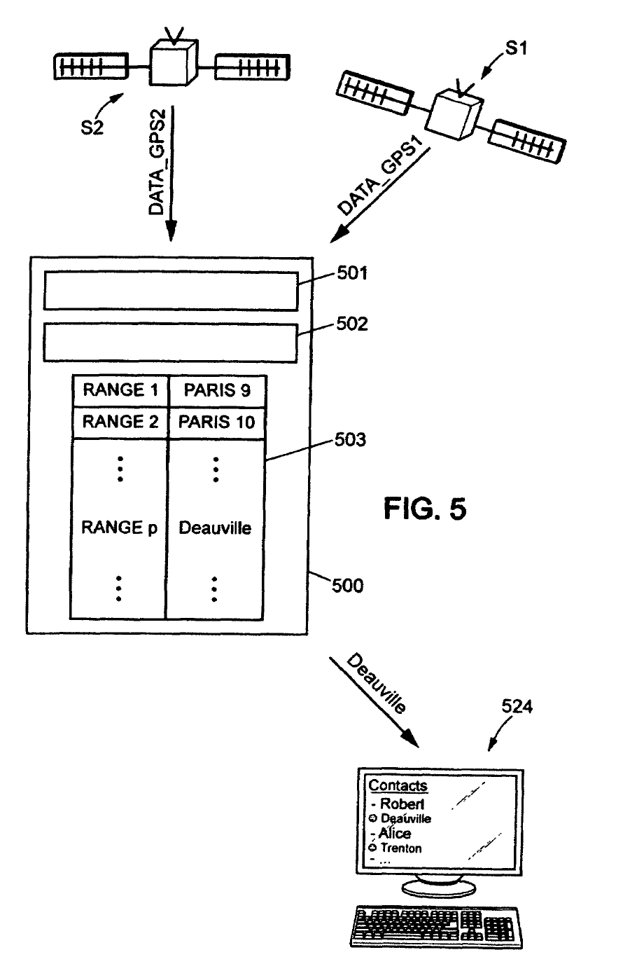

FIG. 5 shows an exemplary terminal device according to an embodiment of the invention, satellites, and terminals of contacts of the user of the terminal.

Identical references denote objects that are identical or similar from one figure to another.

Reference is firstly made to FIG. 1, in which are represented a place of work 1 seen from above, for example an office building or a factory, a zone 2 of range of a local wireless communication network, termed a WLAN network (standing for “Wireless Local Area Network”), a zone 3 of coverage of a wide area radio communication network, termed a WAN network (standing for “Wide Area Network”). At the outset it will be noted that the reference 2 will be used interchangeably to denote the WLAN network and its zone of range. Likewise, the reference 3 will be used interchangeably to denote the WAN network and its zone of coverage.

It will be noted that the zone of coverage of the WAN network 3 is very wide and covers in particular the building 1 and the WLAN range zone 2. The zone 2 of range of the WLAN network covers the building 1 globally. In the example taken, the WLAN zone 2 extends slightly beyond the building 1. Here, the WLAN network 2 is a company protected WiFi network, intended to support WiFi communications for WiFi equipment internal to the company. It comprises a plurality of WiFi access points. For the sake of clarity, a single WiFi access point 4 has been represented in FIG. 1.

Here, the WAN network 3 is a GSM radio communication network. In the particular example of the description, consideration is given to a radio communication terminal 5, in this instance a mobile telephone, able to communicate through the GSM network 3. The terminal 5 integrates wireless reception means, here a radio receiver comprising a WiFi reception antenna 11, an instant messaging tool 13 and processing means, for example a processor 12, for updating an instant messaging presence status of the terminal 5.

FIG. 2 shows a terminal device 5, here a GSM mobile telephone. The device 5 comprises means 11 for detecting a WiFi network comprising an antenna. This antenna makes it possible to receive a message M from a point of access 4′ to a wireless local area network of WiFi type.

This message M comprises an identifier of this network, for example the SSID of this access point 4′.

The terminal 5 comprises first processing means, for example a processor 12, for deducing from the message received M the SSID of the access point 4′ SSID_A.

The terminal device 5 comprises a memory 22 comprising a presence table. Stored in the presence table are a list of SSIDs SSID_1, . . . , SSID_n corresponding respectively to various WiFi wireless local area networks WLAN_1, . . . , WLAN_n, and for each SSID stored, associated presence data HOME, JUDO, . . . , WORK.

The presence data contain information cues regarding adaptation of the presence status, for example an identifier of an icon and an identifier of a personal message.

According to another example, if the adaptation affects only the choice of the personal message, the presence data may each correspond to a personal message. For example, the HOME data correspond to the message “Home Sweet Home”, the JUDO data to the message “At the Judo club” and the “WORK” data to the message “At work”.

According to another example, if the adaptation also affects the presence icon, it is for example possible to make provision for the WORK data to correspond to the “Online-Busy” icon and the personalized message “At work”.

Second processing means, here merged with the first processing means 12, but which may of course be separate from the first processing means, compare the SSID determined by the first processing means SSID_A with the SSIDs SSID_1, . . . , SSID_n stored in the presence table 22.

If one of the comparisons is positive, stated otherwise if the terminal detects that it is in the zone of range of one of the WiFi networks WLAN_1, . . . , WLAN_n, for example the network WLAN_1, the corresponding HOME presence data, associated in memory with the SSID_1 of the network WLAN_1 detected, are used to adapt an instant messaging status of a user of the terminal 5 as a function of the location of this terminal 5. This adaptation of the user's presence status may be performed by recording new parameters or by modifying existing parameters in a memory 23 storing the parameters defining this presence status.

It will be noted here that the parameters defining a presence status may comprise:
a presence icon, selected from a preestablished set of icons and suggested by the instant messaging tool, for example “Online-Available”, “Online-Busy”, “Online-On the telephone” and “Offline”;
a personal message, for example “I am working!”, “Skiing”, etc. defined by the user (this message possibly for example being input by the user or downloaded by him).

The adaptation of the presence status with the aid of the presence data associated with the location of the terminal may affect the choice of the presence icon and/or of the personal message, depending on the content of these personal data.

According to another example, the adaptation may affect only the presence icons. For example, the icon “Online—Busy” corresponds to the JUDO and WORK data, and the icon “Online—Available” corresponds to the HOME data.

The parameters defining the presence status may comprise only presence spots, or only personalized messages.

It is also possible that, when the user uses the terminal 5 to telephone, the parameters are updated by the processor 12 in such a way as to choose the presence icon “Online—On the telephone”.

The parameters defining the presence status and represented under the reference STATUS are dispatched to the terminals 24, 24′ of the various contacts of the user of the terminal 5, optionally when requested by these terminals 24, 24′.

These terminals then display the presence status of the terminal 5. In this example, the presence icon is displayed in the form of an emoticon corresponding to the value of this icon, here “Online-Available”, and the personal message of the HOME presence data, here “Home Sweet Home” is also displayed.

FIG. 3 shows an exemplary algorithm executable by a processor of a terminal 5 according to an embodiment of the invention.

When operating, the terminal 5 listens out for wireless networks within range, so as to be able to detect without any specific request from the user, any wireless network within range. In the particular example of the description, the terminal uses active listening based on the broadcasting of a probe request, during a step 30.

In response to such a probe request, a WiFi access point within range may dispatch a probe response to the terminal, so as to signal its presence to the terminal. This probe response is received by the terminal during a step 31.

In a first active listening mode, the probe request broadcast by the terminal contains a null SSID identifier (“SSID=NULL”), that is to say unspecified, and the probe response of the access point within range contains the SSID SSID_A of the WiFi network to which it belongs, in so far as one is dealing with a WiFi network whose SSID is not hidden.

During a step 44, the SSID of the detected network SSID_A is determined on the basis of the probe response message.

In a second active listening mode (not illustrated by FIG. 3), the terminal emits for each of its favourite networks, that is to say for each of the networks whose connection profile is recorded in the terminal, a probe request containing the SSID identifier of this favourite network, such as specified in a recorded connection profile. If the terminal receives a positive response message from an access point, the presence status is updated by taking account of the SSID transmitted in the probe request for which the response message is positive.

This second active listening mode is used for the favourite WiFi networks of the terminal, even if one is dealing with networks concealing their SSID identifier. The active listening of the terminal may combine these two modes of active listening.

It would also be conceivable for the terminal to use passive listening, based on listening for beacon frames, called “beacons”, emitted by WiFi access points and able to contain the SSID identifier of the relevant WiFi network.

These various modes of listening for wireless networks within range are well known to the person skilled in the art and will therefore not be described further in the present description. Nevertheless, for fuller information on this subject, the reader is invited to refer to the document “802.11 Wireless Networks: The Definitive Guide”, second edition, by Matthew Gast, published by O'REILLY.

In a general manner, if the terminal detects a WiFi network within range, it identifies this network by determining its SSID identifier, in so far as one is dealing with a network whose SSID identifier is not hidden or else a favourite network.

To return to FIG. 3, once the terminal knows the identifier SSID_A of the WiFi network detected, it compares this identifier SSID_A with the identifier or identifiers SSID_1, . . . , SSID_n of the network or networks prerecorded in the terminal. It will be noted that this step is also carried out without the user's intervention.

These comparisons may be implemented with the aid of a loop 33 comprising conventional steps of initialization, testing 38 and incrementation. The loop 33 furthermore comprises a step 34 of comparing the identifier SSID_A with one of the SSIDs stored SSID_i.

It will be understood that SSID_i is intended to mean the i^{th} SSID stored, for example SSID_1 for i=1, SSID_2 for i=2, etc.

If the identifier SSID_A is not recognized among the SSIDs stored, the loop is exited during the test 38. A step 40 of displaying a message NEW_NETWORK signalling to the user that a new network has been detected and suggesting to the user that he input presence data to be associated with the identifier SSID_A may be executed. If the user inputs presence data DP, that is to say if the test 41 is positive, the SSID of the new network SSID_A and the presence data DP input are recorded as associated with this SSID, during steps 42 and 43.

If the identifier SSID_A is recognized as identical to one of the prerecorded identifiers SSID_i, the presence data DP_i associated with the identifier SSID_i are read during a step 35, and the presence status is adapted during a step 36, as a function of the presence data DP_i.

Finally, the new presence status is transmitted during a step 37 to the terminals of the contacts of the user of the terminal.

The comparisons of the loop 33, the reading of step 35 and the adaptation of the presence status of step 36, may be performed only if a mode variable MODE_BIT has a given value, for example 0. For this purpose, provision may be made for a step 39 of reading this variable MODE_BIT, here a mode bit, followed by a step of testing 32 as to the value of this variable.

Let us take the example of the terminal 5 entering the building 1, with reference to FIG. 1. Initially, the terminal 5 is outside the premises of the company, and outside the zone of range of the company WiFi network 2.

When the terminal 5 is in the building 1, or slightly before entering it, the terminal 5, listening out for WiFi networks within range, detects a WiFi network within range and then identifies the network detected by determining the SSID identifier of this network.

The network 2 is thereafter recognized by the terminal 5 as a prerecorded network, during the comparisons of the loop 33 of FIG. 3. The terminal then adapts the instant messaging presence status of the terminal 5, as a function of the presence data corresponding to the prerecorded network recognized.

Let us now consider that the terminal 5, which is in the building 1 and whose presence status indicates that the user is at his place of work, leaves the building 1 and moves far enough away from it as to leave the WiFi zone of range 2. The terminal 5 then detects, without the user's intervention, that it is no longer within range of the WiFi network 2. More precisely, the terminal 5 detects here that it is no longer within range of the network 2 as soon as it does not detect this network for a duration greater than or equal to a predefined duration T, termed the “timer” duration. Provision may be made for this detection to bring about an updating of the instant messaging presence status, for example by cancelling the last adaptation of this presence status.

As a variant, it would be conceivable for a network unavailability cue to be dispatched to the terminal 5 in the form of a message, when the terminal leaves the zone of range of the network 2. The use of a timer would then not be necessary.

The terminal 5 uses an existing infrastructure of a wireless local area network, here the infrastructure of a company WiFi network 2 intended for supporting communications between the company's WiFi equipment, as a means for detecting whether it is in the premises of the company, or possibly nearby, and, as appropriate, adapting the instant messaging presence status of the terminal. Thus, it is not necessary to deploy a specific additional infrastructure in the premises of the company in order to have the presence statuses of the terminals present in these premises adapted automatically.

Furthermore, when a user leaves the premises of the company, for example to go back home, his terminal may again adapt the presence status, without the user's intervention, simply through the fact that he is no longer within range of the company WiFi network 2. The user therefore no longer has to concern himself with modifying his presence status manually after having left his place of work.

FIG. 4 is a flowchart of an exemplary method according to another embodiment of the invention. In this example, the terminal seeks to detect cellular networks, for example GSM networks, during a step 400. The terminal is able to detect more than one cellular network.

In the event of detection(s), the terminal deduces from message(s) received one or more cell identifier(s) Cell_ID_Aⱼ, j running from 1 to m, during a step 401.

These identifiers Cell_ID_Aⱼ are compared with prerecorded cell identifiers Cell_ID_i, the index i running from 1 to n. A loop with conventional steps of initializing the indices i and j, of tests, and of incrementations is implemented so as at one and the same time to run through the identifiers Cell_ID_Aⱼ received in step 401, and the prerecorded identifiers Cell_ID_i.

A comparison step 403 is performed during each execution of the loop.

In the event of a positive comparison, during a step 404, the indices i, j for which the comparison is positive are preserved, and a variable NB_CELLS previously initialized to zero during a step 405 is incremented.

A test 406 is performed at the loop output, as to the value of this variable NB_CELLS. If this variable is strictly greater than 1, that is to say if the terminal has detected more than one network whose identifier is prerecorded, comparisons of power, or of amplitude, or of signals are performed so as to choose the network for which reception is best. The signals whose power is compared during a step 407 may be the analogue signals received by the terminal in step 401. The way in which these comparisons may be conducted is well known to the person skilled in the art and will not be detailed further.

Once the network for which reception is best has been selected, in step 408, a reading is performed, during a step 409, of the prerecorded presence data DP_i₀ and corresponding to the prerecorded network identifier Cell_ID_i₀ identical to the identifier Cell_ID_Aⱼ₀ of the network for which reception is best.

If the terminal has detected a single network whose identifier is prerecorded, that is to say if the test 410 is a success, a reading of the prerecorded presence data DP_i corresponding to this prerecorded identifier Cell_ID_i is performed during a step 411.

Next, the presence data read are used to adapt the instant messaging presence status, during a step 412.

According to an alternative embodiment (not represented), provision may be made, in respect of each base station, for example GSM base stations, from which a message is received, to quantify an amplitude or a power of the analogue signals corresponding to this message. On the basis of these quantified amplitudes, it is possible to calculate for example by triangulation a location cue for the terminal, for example spatial coordinates. The presence status may be updated as a function of the spatial coordinates thus determined.

FIG. 5 shows an exemplary terminal 500, according to another embodiment of the invention.

This terminal 500, for example a portable telephone, here comprises a GPS receiver. The terminal 500 comprises a module 501 for receiving GPS data, originating from a plurality of satellites, for example three or four satellites, even if only two satellites S1, S2 are represented here.

These satellites S1, S2 dispatch messages DATA_GPS1, DATA_GPS2, comprising for example an indication of the distance separating the GPS receiver 500 from each satellite S1, S2.

The receiver 500 comprises calculation means, for example a processor 502, able to determine a location cue for the receiver 500 on the basis of the messages DATA_GPS1, DATA_GPS2 received, for example by triangulation. The receiver location thus calculated may comprise a latitude, a longitude and possibly a height, or other spatial coordinates.

According to an alternative embodiment (not represented), the presence status is updated directly with the aid of these calculated coordinates. These coordinates are transmitted to the terminals of the contacts of the user of the terminal 500, with a view to comparisons so as to associate a geographical place with these coordinates in order to display this place as presence status of the user of the terminal 500.

To return to FIG. 5, a table 503 makes it possible to associate with the location calculated an indication of a geographical place, for example a district, a village or the like. The table 503 can be structured as indications of geographical places, each indication corresponding to intervals of values of spatial coordinates.

Table 503 can be contained in the terminal 500, as represented in FIG. 5, or else in another device, possibly remote.

The receiver location calculated by the processor 502 is compared with the various intervals of the table 503, so as to determine an indication of geographical place corresponding to the location cue calculated. The presence status is updated using the determined indication of geographical place.

It may be the processor 502 which performs the comparisons and the updates of the presence status.

The presence status is transmitted to the terminals of the contacts of the user of the terminal 500. The presence status may comprise only an indication of geographical place, as represented in FIG. 5.

It will be noted that provision may be made for types of personal data other than a personal message. The personal data may for example comprise an image or an animation, preferably of similar dimensions to the dimensions of an icon, or else an icon. The personal data may for example be downloaded by the user.

1. A method for adapting a presence status of a user of a terminal, comprising
receiving a message at the terminal by means of a wireless link,
determining, on the basis of the received message, a location cue for the terminal,
comparing the location cue for the terminal with at least one prerecorded location cue and
in the event of a positive comparison, the at least one prerecorded location cue being associated in memory with presence data predefined by the user, adapting the status of the user as a function of the presence data associated with the location of the terminal.

2. The method according to claim 1, wherein the location cue for the terminal comprises an identifier of a wireless local area network and, during the comparison step, the identifier of the local area network is compared with at least one prerecorded identifier relating to at least one wireless local area network.

3. The method according to claim 2, wherein there is provided a configuration step in the course of which
at least one location cue, relating to a given location, is recorded in the terminal,
for the given location, presence data are recorded in such a way as to associate in memory said presence data with the corresponding location cue.

4. The method according to claim 1, wherein the presence data defined by the user for a given location comprise personal data provided by the user.

5. The method according to claim 1, wherein the presence data defined by the user for a given location comprise a presence icon, selected by the user from a set of presence icons provided by an instant messaging tool.

6. The method according to claim 1, comprising
receiving at the terminal a plurality of messages originating from a plurality of separate respective devices,
and determining the location cue on the basis of the messages of said plurality of messages.

7. The method according to claim 1, further comprising
reading the value of a mode variable, said value conditioning the carrying out of the step of adapting the presence status.

8. A terminal device equipped with instant messaging, and comprising
wireless reception means,
first processing means able to determine on the basis of a message received by the wireless reception means a location cue for the terminal and
second processing means able to
compare the location cue for the terminal with at least one prerecorded location cue and
in the event of a positive comparison, the at least one prerecorded location cue being associated in memory with presence data predefined by the user, adapt the status of the user as a function of the presence data associated with the location of the terminal.

9. A computer program comprising instructions for implementing the method according to claim 1, when said instructions are executed by a processor.
